(19) United States
(12) Patent Application Publication
(10) Pub. No.: US 2026/0349473 A1
(43) Pub. Date: Nov. 5, 2026

(54) MULTIFUNCTIONAL HUB

(71) Applicant: OXTI Pte Ltd, Singapore (SG)

(72) Inventor: YU-LIN LIN, Singapore (SG)

(21) Appl. No.: 19/199,338

(22) Filed: May 5, 2025

(51) Int. Cl. G06F 1/16; G06F 3/0354; H01Q 1/22

(52) U.S. Cl. CPC G06F 1/1632; G06F 3/03543; H01Q 1/2266

(57) ABSTRACT

The multifunctional hub includes a hub body and a mouse. The hub body includes a power port, multiple external ports, a circuit board, and an artificial intelligence (AI) module. The circuit board is configured inside the hub body, and is equipped with a socket. The AI module is installed on the socket, which is respectively connected to the power port and the external ports. The mouse is wirelessly connected to the AI module, and includes a mouse circuit board. The mouse circuit board includes at least one electronic circuit and a microphone. As the AI module is installed on the socket of the hub body, this setup improves upon the conventional approach of placing the AI module within the mouse or an external wireless signal transceiver, reducing the risk of losing smart functionality due to the loss of the mouse or transceiver, and enhancing overall stability and reliability.

### BACKGROUND OF THE INVENTION

### (a) Technical Field of the Invention

The present invention generally relates to hubs, and more particularly to a multifunctional hub.

### (b) Description of the Prior Art

A Universal Serial Bus (USB) hub is an expansion device designed to increase the number of available USB ports, allowing connection to external devices such as keyboards, USB flash drives, external hard drives, and printers.

For example, Taiwan Patent No. M379260 describes a “USB Hub” that includes several USB ports for connecting multiple computer peripheral devices to enable electrical and data transmission. Each USB port is electrically connected to a DIP switch, which allows the user to control the power supply status of each USB port by toggling a corresponding switch.

On another hand, due to the recent advancement of artificial intelligence (AI) technology, there are wireless mice equipped with AI functionalities. However, placing AI module within a wireless mouse or in an external wireless signal transceiver may pose a risk. If the mouse or external transceiver is lost—for instance, the external transceiver may be misplaced due to repeated plugging and unplugging, or the mouse may be obscured by clutter on a desk—the smart operation functions may become unavailable, presenting a usability risk.

### SUMMARY OF THE INVENTION

The present invention discloses a novel multifunctional hub, which includes a hub body and a mouse. The hub body includes a power port, multiple external ports, a circuit board, and an artificial intelligence (AI) module. The circuit board is configured inside the hub body. The circuit board is equipped with a socket, and the AI module is installed on the socket. The AI module is respectively connected to the power port and the external ports. The mouse is wirelessly connected to the AI module. The mouse includes a mouse circuit board, and the mouse circuit board includes at least one electronic circuit and a microphone.

Specifically, the hub body further includes a first antenna, which is connected to the AI module.

Specifically, the hub body further includes a first antenna, a trigger circuit, and a button. The first antenna is connected to the trigger circuit. The trigger circuit is connected to the button.

Specifically, the mouse further includes a second antenna. The at least one electronic circuit of the mouse circuit board includes a transmission circuit and a first amplification circuit. The second antenna is connected to the transmission circuit. The transmission circuit is connected to the first amplification circuit. The first amplification circuit is connected to the microphone.

Specifically, the mouse further includes a second antenna. The at least one electronic circuit of the mouse circuit board includes an alert circuit, a second amplification circuit, and a buzzer. The second antenna is connected to the alert circuit. The alert circuit is connected to the second amplification circuit. The second amplification circuit is connected to the buzzer.

Accordingly, the AI module is installed on the socket of the hub body, allowing the multifunctional hub not only to retain the traditional mouse functionality but also to incorporate the AI module, thereby enabling the mouse to support voice control, wireless connectivity, and intelligent operation. In addition, this setup improves upon the conventional approach of placing the AI module within the mouse or an external wireless signal transceiver, reducing the risk of losing smart functionality due to the loss of the mouse or transceiver, and enhancing overall stability and reliability.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a multifunctional hub according to an embodiment of the present invention.

FIG. 2 is a perspective diagram showing the installation of an artificial intelligence (AI) module on a circuit board's socket in the multifunctional hub of FIG. 1.

FIG. 3 is a functional block diagram showing the multifunctional hub of FIG. 1.

FIG. 4 is a sectional diagram showing an artificial intelligence (AI) module before its installation on a circuit board's socket in the multifunctional hub of FIG. 1.

FIG. 5 is a sectional diagram showing an artificial intelligence (AI) module after its installation on a circuit board's socket in the multifunctional hub of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

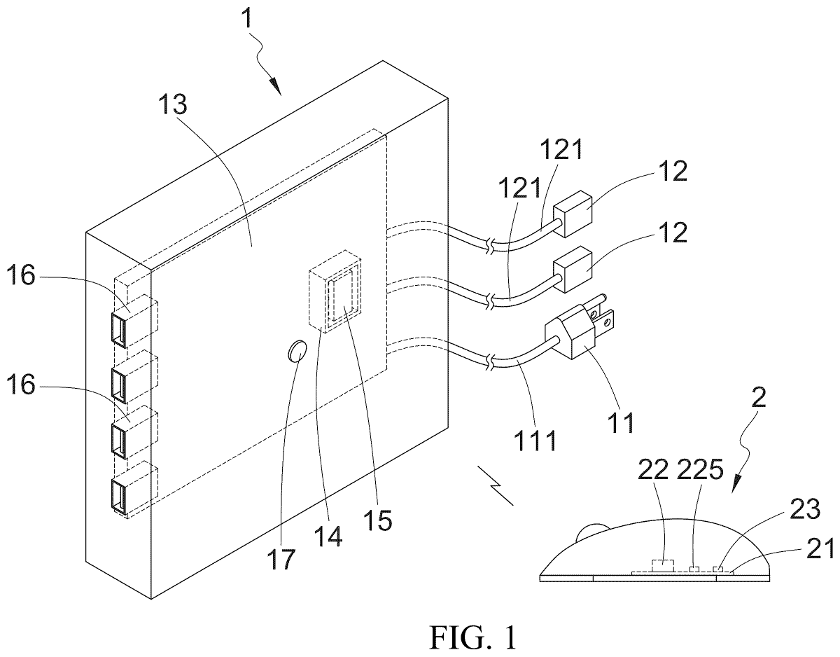

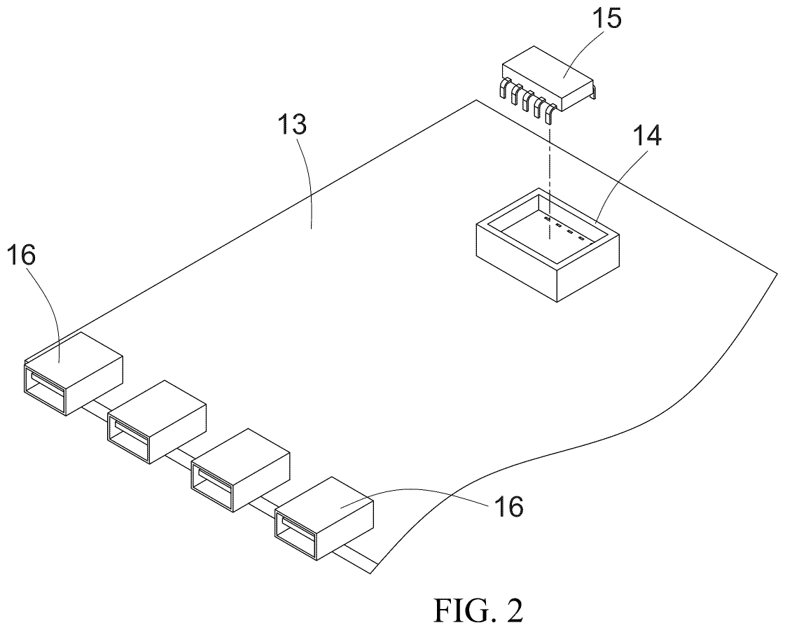

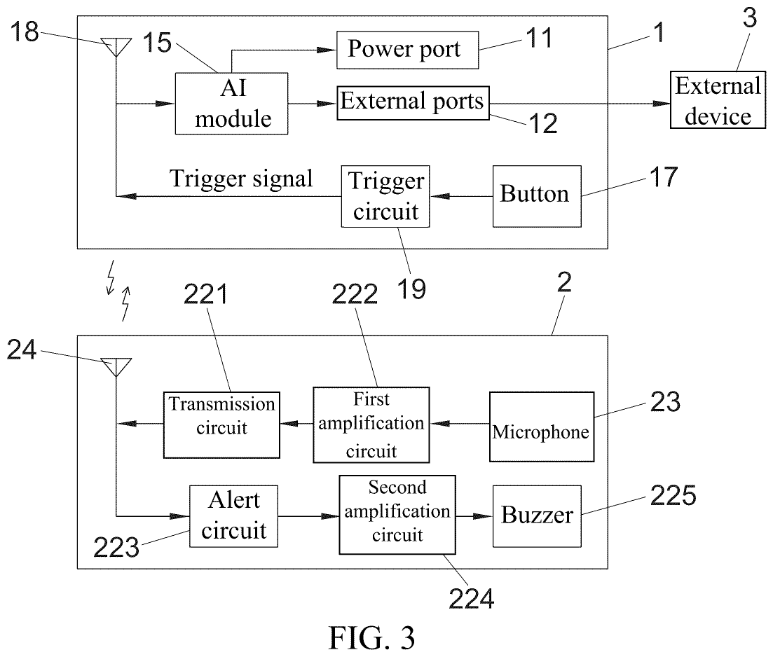

As shown in FIGS. 1 to 3, a multifunctional hub according to an embodiment of the present invention, which includes the following components.

A hub body 1 is configured with a power port 11 and multiple external ports 12. Inside the hub body 1 is a circuit board 13, and the circuit board 13 is equipped with a socket 14. An artificial intelligence (AI) module 15 is installed on the socket 14, which is respectively connected to the power port 11 and the external ports 12.

The AI module 15 is a hardware module that includes an AI processor and related electronic components, specifically designed to perform AI computations such as image recognition, voice processing, and other functions. The AI module 15 may be in the form of a chip, integrating relevant electronic components to carry out AI-related tasks. In addition to the AI processor, the AI module 15 may also include storage components, such as a solid-state drive (SSD) or memory (RAM), which can be used to store large volumes of data and training models. One example of a training model is a large language model (LLM). A large language model is a type of training model used in natural language processing (NLP). It is typically trained on massive amounts of language data and is capable of understanding, generating, translating, and responding to language-related queries.

In the present embodiment, the multifunctional hub is a Universal Serial Bus (USB) hub. The hub body 1, therefore, includes a front panel and a rear panel, and the front panel is equipped with multiple USB ports 16, which can be used to connect devices such as a keyboard, USB flash drive, external hard drive, printer, and so on. The rear panel of the hub body 1 is equipped with the power port 11 and the external ports 12. To facilitate connection to various external power sources (e.g., different power outlets, power adapters, or USB power supplies), the power port 11 may be equipped with a connection cable 111 to extend the reach of the power connection. In the present embodiment, the power port 11 is in the form of a plug for direct insertion into a power outlet. The connection cable 111 of the power port 11 may pass through the rear panel of the hub body 1 and further through the circuit board 13 to connect with the socket 14. The power port 11 is used to connect with an external power source to supply the necessary power for the AI module 15. Specifically, the power supplied by the external source is transmitted through the circuit board 13 to the socket 14, and the socket 14 then delivers the power to the AI module 15 mounted on it, ensuring its proper operation. The circuit board 13 may be equipped with a voltage regulation circuit to convert the voltage from the power port 11 into a stable voltage suitable for the AI module 15, thereby preventing voltage fluctuations from affecting its operation. Additionally, the circuit board 13 may include current protection mechanisms (such as fuses or overcurrent protection ICs) to prevent the AI module 15 from being damaged by excessive current.

To facilitate connection to various external devices 3 (such as different input devices, storage devices, display devices, or communication devices), the external ports 12 may be equipped with connection cables 121 to extend the reach for connecting external devices. The connection cables 121 of the external ports 12 may pass through the rear panel of the hub body 1 and connect to the socket 14. The external ports 12 are used to interface with external devices. The data or signals provided by these external devices are transmitted through the circuit board 13 to the socket 14, which then relays the data or signals to the AI module 15 mounted on the socket 14. The data or signals are processed by circuitry on the circuit board 13, such as analog-to-digital converter (ADC) circuits, which convert analog data collected from external devices into digital signals for transmission to the socket 14. If the data or signals are transmitted directly to the socket 14, they may be affected by noise or interference—especially when multiple external devices are connected simultaneously—potentially resulting in data errors or signal conflicts. To prevent this, the circuit board 13 typically also includes signal amplification, filtering, and regulation circuits to ensure that signals are transmitted without distortion or attenuation, thereby enhancing signal quality and reliability.

The hub body 1 is also equipped with a first antenna 18, which is connected to the AI module 15 to enable wireless connectivity. In addition to the first antenna 18, the hub body 1 may further include a trigger circuit 19 and a button 17. The first antenna 18 is connected to the trigger circuit 19, which in turn is connected to the button 17.

When a user presses the button 17, the trigger circuit 19 generates a trigger signal and transmits it through the first antenna 18. The trigger signal can be used to communicate with an external device. By performing a simple action (pressing the button), the user can send the trigger signal, enhancing ease of use and operational flexibility.

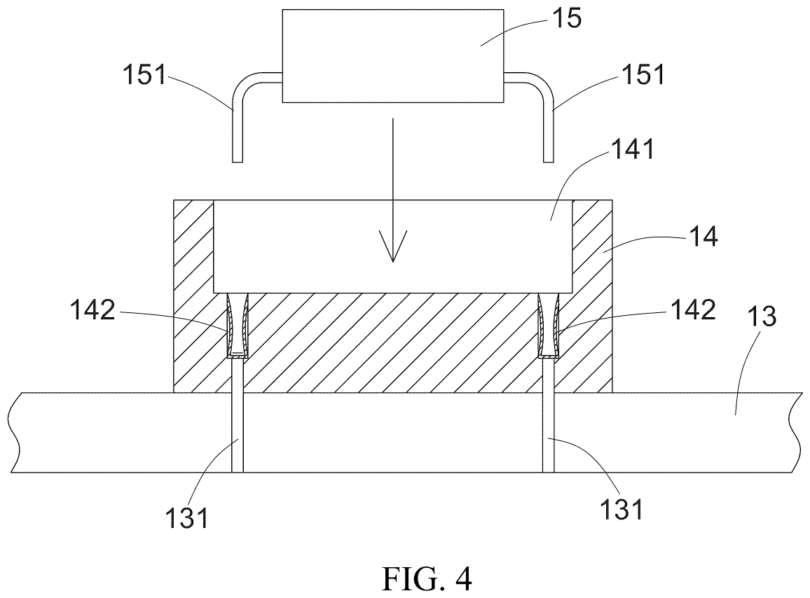

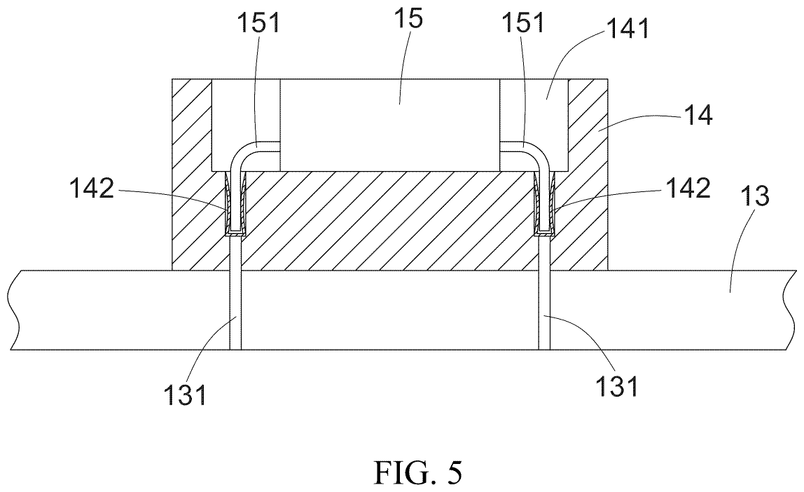

As shown in FIGS. 4 and 5, the AI module 15, in chip form in the present embodiment, is installed in a receiving space 141 of the socket 14. Leads 151 of the AI module 15 are correspondingly inserted into pins 142 of the socket 14, thereby forming an electrical connection between the pins 142 of the socket 14 and the leads 151 of the AI module 15. These pins 142 of the socket 14 are further connected to the pin holes 131 on the circuit board 13, forming a conductive path and enabling signal transmission between the AI module 15 and the circuit board 13. The pins 142 of the socket 14 may use flexible elements (such as metal spring clips) to clamp the leads of the chip, ensuring reliable contact and preventing poor connectivity.

As shown in FIGS. 1 to 3, a mouse 2 is wirelessly connected to the AI module 15. The mouse 2 includes an internal mouse circuit board 21, which is equipped with at least one electronic circuit 22, and the mouse 2 is also provided with a microphone 23.

The mouse 2 further includes a second antenna 24. The electronic circuit 22 of the mouse circuit board 21 may include a transmission circuit 221 and a first amplification circuit 222. The second antenna 24 is connected to the transmission circuit 221, which in turn is connected to the first amplification circuit 222. The first amplification circuit 222 is connected to the microphone 23. The second antenna 24 of the mouse 2 is wirelessly connected to the first antenna 18 of the hub body 1, enabling wireless interaction between the mouse 2 and the hub body 1.

The function of the transmission circuit 221 is to convert the signal from the microphone 23 into radio waves, which are then transmitted via the second antenna 24. Specifically, the transmission circuit 221 converts the captured sound into a radio frequency (RF) signal, which is then transmitted through the second antenna 24. The purpose of the first amplification circuit 222 is to amplify the signal strength. Since the signal generated by the microphone 23 is typically weak, it needs to be amplified by the first amplification circuit 222 before transmission, so that it can be effectively processed and transmitted by the transmission circuit 221.

The electronic circuit 22 of the mouse circuit board 21 may further include an alert circuit 223, a second amplification circuit 224, and a buzzer 225. The second antenna 24 is connected to the alert circuit 223, which is connected to the second amplification circuit 224. The second amplification circuit 224 is connected to the buzzer 225. The function of the alert circuit 223 is to monitor the trigger signal from the button 17. When the alert circuit 223 detects a trigger signal, it generates an alert signal. The purpose of the second amplification circuit 224 is to amplify the alert signal from the alert circuit 223 to ensure that the signal is strong enough to drive the buzzer 225 to emit a clear and sufficiently loud alarm sound. The buzzer 225 functions to emit various alarm sounds.

The multifunctional hub has a feature for locating the mouse 2. When the mouse 2 cannot be found, the user can press the button 17. The trigger circuit 19 will generate a trigger signal and transmit it through the first antenna 18. The alert circuit 223 monitors the trigger signal. When the alert circuit 223 detects the trigger signal, it generates an alert signal, which is then amplified by the second amplification circuit 224 to ensure that the alert signal is strong enough to drive the buzzer 225 to emit a clear and sufficiently loud alarm sound.

In addition, the mouse 2 may be equipped with a unique identification code. Through the collaborative operation of the AI module 15 and the alert circuit 223, the system can locate a specific mouse 2 among multiple mice. When a specific mouse 2 cannot be located and there are many mice nearby, the user can press the button 17. The trigger circuit 19 will generate a trigger signal and transmit it via the first antenna 18 to the mice. Upon detecting the trigger signal, the alert circuit 223 of the mouse 2 communicates with the AI module 15 of the hub body 1, which identifies the unique ID of the specific mouse 2 and filters out other mice, ensuring that only the designated mouse 2 responds—thus avoiding false activation. Once confirmed, the alert circuit 223 generates an alert signal, which is amplified by the second amplification circuit 224 to ensure it is strong enough to drive the buzzer 225 to emit a loud alarm sound, helping the user locate the specific mouse 2.

As such, the AI module 15 is installed on the socket 14 of the hub body 1, allowing the multifunctional hub to not only retain the traditional functions of a mouse but also incorporate the AI module 15, thereby enabling the mouse 2 to support voice control, wireless connectivity, and intelligent operation. Moreover, since the AI module 15 is built into the hub body 1, it avoids the conventional approach of placing the AI module 15 inside the mouse or in an external wireless signal transceiver. This design effectively prevents situations where intelligent functions become unusable due to the loss of the mouse or the external transceiver. Furthermore, because the front panel of the hub body 1 is equipped with multiple USB ports 16 and the rear panel has multiple external ports 12, it allows for expanded connectivity. In addition, the buzzer 225 can emit a loud alarm sound to help users quickly and easily locate the mouse 2.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A multifunctional hub, comprising:
a hub body comprising a power port, a plurality of external ports, a circuit board, and an artificial intelligence (AI) module, where the circuit board is configured inside the hub body, the circuit board is equipped with a socket, and the AI module is installed on the socket, and the AI module is respectively connected to the power port and the external ports; and
a mouse wirelessly connected to the AI module, where the mouse comprises a mouse circuit board, the mouse circuit board comprises at least one electronic circuit and a microphone.

2. The multifunctional hub according to claim 1, wherein the hub body further comprises a first antenna, which is connected to the AI module.

3. The multifunctional hub according to claim 1, wherein the hub body further comprises a first antenna, a trigger circuit, and a button; the first antenna is connected to the trigger circuit; and the trigger circuit is connected to the button.

4. The multifunctional hub according to claim 1, wherein the mouse further comprises a second antenna; the at least one electronic circuit of the mouse circuit board comprises a transmission circuit and a first amplification circuit; the second antenna is connected to the transmission circuit; the transmission circuit is connected to the first amplification circuit; and the first amplification circuit is connected to the microphone.

5. The multifunctional hub according to claim 1, wherein the mouse further comprises a second antenna; the at least one electronic circuit of the mouse circuit board comprises an alert circuit, a second amplification circuit, and a buzzer; the second antenna is connected to the alert circuit; the alert circuit is connected to the second amplification circuit; and the second amplification circuit is connected to the buzzer.
